(19) United States
(12) Patent Application Publication
(10) Pub. No.: US 2015/0172228 A1
(43) Pub. Date: Jun. 18, 2015

(54) METHOD AND SYSTEM FOR COMMUNICATING INFORMATION OVER A NETWORK

(71) Applicants: George Zalepa, New York, NY (US); Nicholas Martin, Austin, TX (US)

(72) Inventors: George Zalepa, New York, NY (US); Nicholas Martin, Austin, TX (US)

(21) Appl. No.: 14/132,405

(22) Filed: Dec. 18, 2013

(51) Int. Cl. H04L 12/58

(52) U.S. Cl. CPC H04L 51/04

(57) ABSTRACT

The present disclosure relates to providing real time or near real-time communication between client devices. In one embodiment, the disclosure allows users to communicate with other users present on a domain or webpage while allowing for a unified communications platform such that a user may communicate with other users on any and all domains/webpages. Thus, a user is constantly connected to other users viewing any given webpage. Additionally, the present disclosure allows users to “check in” to webpages and domains.

### CROSS-REFERENCE TO RELATED APPLICATION

This application is a continuation application of, and claims priority from U.S. patent application Ser. No. 13/865,133, filed Apr. 17, 2013, entitled “A Method and System For Communicating Information Over A Network,” which claims the benefit of priority from U.S. Provisional Application No. 61/625,337, filed Apr. 17, 2012, which are both incorporated herein by reference.

This application includes material that is subject to copyright protection. The copyright owner has no objection to the facsimile reproduction by anyone of the patent disclosure, as it appears in the Patent and Trademark Office files or records, but otherwise reserves all copyright rights whatsoever.

### BACKGROUND

The increased availability of networks, such as the Internet or intranets, has increased accessibility among devices coupled to the networks. Example communications across such networks include electronic mail (“e-mail”), file transfer, web browsing, instant messaging, voice and video communications, and other exchanges of data.

Real-time mechanisms of communicating between users may be provided by chat sessions or instant messaging. Both instant messaging and chat sessions are communications services that allow two or more individuals to establish real-time or near real-time communications sessions. Instant messaging (IM) technology generally enables two or more participants to communicate over a computer network, such as the Internet or an internet (e.g., a private network), in more or less real time. Typically, each participant uses a client computer system to send and receive messages (including, e.g., text, voice, files, and the like) via a user interface. Each client computer in communication is connected via a network to an instant messaging service provider and connection server and, in some embodiments, a conferencing server if the user is engaging in multi-user chat (“MUC”). The connection servers receive and process messages from participants and forwards them to the client systems of the other participants for display. The connection servers may also be configured to send messages on behalf of the system, such as to inform participants that a fellow participant has disconnected (i.e., logged off), logged on, joined a chat room and other similar actions.

Instant messaging software may be made available for download, for example, from a web page accessible via the Internet or an online store or marketplace. Other types of IM software may be provided via a server provided application programming interface (“API”). A user invokes this software on the client system in order to communicate by instant message with one or more other participants. The client side application software typically establishes a connection between the client system and the connection server and either automatically logs the user into the connection server or prompts the user to enter the information necessary to log in, such as a user name and password. The user may then communicate by means of instant messaging with one or more other users who are logged into the instant messaging system at that time.

There are several instant messaging systems and service providers, such as MSN MESSENGER®, YAHOO! MESSENGER®, GOOGLETALK®, AOL INSTANT MESSENGER® (“AIM”), and the like. These message clients also fail to provide the ability to communicate across different platforms and/or between domains or sub-domain levels. Furthermore, such platforms/message clients only provide a user with the ability to communicate (or chat) with users with whom they have an established relationship with. That is, a user may only communicate with another user if they are each on their friend listing. In addition, if a destination user is not logged on to a predetermined server, then that user is basically unavailable over data networks at that time.

### SUMMARY OF THE DISCLOSURE

There is no established technology that enables users to communicate with other users who have visited, or are currently visiting certain web sites. Indeed, there is no existing platform that enables users to share their current (or past) behavior or activity across web-platforms. Therefore, a need thus exists for a more robust method and apparatus for communicating over data networks. Accordingly, it is desirable to allow communication and interoperability between two or more networks for instant messaging and sharing of information. Further, it is desirable to provide presence indicators for participants associated with one or more external networks and instant/or messaging providers.

Techniques that enable instant communications services to be provisioned for an online community of users such that the members of the community can interact with each other using instant communications including using instant messaging (IM). In one embodiment, an instant communications facilitator operating from a first domain may provision instant communication services for members of an online community maintained in different domains from the first domain.

Embodiments of the present disclosure provision instant communication services for members of an online community. As a result of the provisioning, the members of the online community are able to send messages to one another using instant communication technologies. Such messages can between known and unknown users. That is, messages can be communicated between users who have an established relationship. Messages can also be communicated between users who share similar activity (e.g., visiting the same site). Instant communication technologies include technologies that enable the real-time delivery of messages between at least one sender and one receiver and may involve maintaining a connection to a service to receive the messages. Examples of instant communication technologies include instant messaging (IM), presence and status messages, multi-user chat, multi-media communication such as voice or video chat, the instant delivery of alerts, notifications, live feeds and other application messages used to create other instant communication applications.

Embodiments of the present disclosure further provide the ability for users to de-mark their activity on a network and/or within an online community. For example, a user may be able to alert other users of instances activity on a web page or domain or sub-domain level activity.

Note: As will be discussed in detail below, the embodiments will be discussed relating to chatting and communication functionality. It should be understood that such communications or chats can include, but are not limited to, text, image, video (live/streaming or video clips), or any other type of data disseminations between users.

### BRIEF DESCRIPTION OF THE DRAWINGS

The foregoing and other objects, features, and advantages of the disclosure will be apparent from the following more particular description of embodiments as illustrated in the accompanying drawings, in which reference characters refer to the same parts throughout the various views. The drawings are not necessarily to scale, emphasis instead being placed upon illustrating principles of the disclosure.

FIG. 1 depicts a system architecture according to some embodiments of the present disclosure;

FIG. 2 depicts is a schematic diagram illustrating a client device in accordance with some embodiments of the present disclosure;

FIG. 3 depicts a schematic block diagram illustrating components of a system according to some embodiments of the present disclosure;

FIG. 4 depicts a system architecture according to some embodiments of the present disclosure;

FIG. 5 depicts a browser environment according to some embodiments of the present disclosure;

FIG. 6 is a flow diagram illustrating steps performed in accordance with some embodiments of the present disclosure;

FIG. 7 is a flow diagram illustrating steps performed in accordance with some embodiments of the present disclosure;

FIG. 8 is a flow diagram illustrating steps performed in accordance with some embodiments of the present disclosure;

FIG. 9 illustrates a non-limiting example in accordance with embodiments of the present disclosure;

FIG. 10 illustrates a non-limiting example in accordance with embodiments of the present disclosure; and

FIG. 11 is a block diagram illustrating architecture of a hardware device in accordance with one or more embodiments of the present disclosure.

### DETAILED DESCRIPTION

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices to select and present media related to a specific topic. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer, special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure a computer readable medium (or computer-readable storage medium/media) stores computer data, which data can include computer program code (or computer-executable instructions) that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

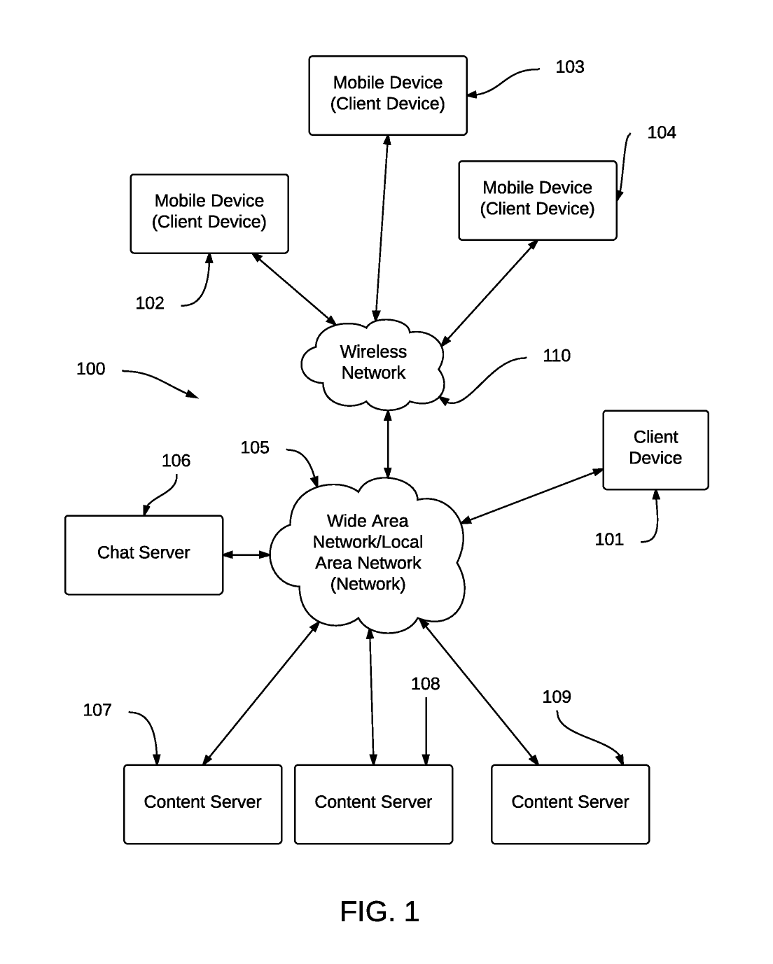

The preferred embodiments of the present disclosure will now be described with reference to FIGS. 1-11. FIG. 1 depicts a system architecture according to some embodiments of the present disclosure. In the embodiment that FIG. 1 illustrates, a system 100 comprises a plurality of mobile devices 102, 103, 104; a wireless network 110; a wide area network or local area network 105; a client device 101; a plurality of content servers 107, 108, 109; and a chat server 106.

Other embodiments that may vary, for example, in terms of arrangement or in terms of type of components, are also intended to be included within claimed subject matter. As shown, FIG. 1, for example, includes a variety of networks, such as local area local area network (LAN)/wide area network (WAN) 105 and wireless network 110, a variety of devices, such as client device 101 and mobile device 102, and a variety of servers, such as content server 107 and chat server 106. In connection with the illustrated example, which is non-exhaustive, additional or fewer servers may be utilized to transmit (and/or store data) between users, as will be understood from the below discussion.

For purposes of this disclosure, a “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server.

In conjunction with the depiction illustrated in FIG. 1, and discussed herein, servers may vary widely in configuration or capabilities, but generally a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

A content server may include a device that includes a configuration to provide content via a network to another device. A content server may, for example, host a site, such as a social networking site, examples of which may include, without limitation, Flicker, Twitter, Facebook, LinkedIn, or a personal user site (such as a blog, vlog, online dating site, etc.). A content server may also host a variety of other sites, including, but not limited to business sites, educational sites, dictionary sites, encyclopedia sites, wikis, financial sites, government sites, etc.

A content server may further provide a variety of services that include, but are not limited to, web services, third-party services, audio services, video services, email services, instant messaging (IM) services, SMS services, MMS services, FTP services, voice over IP (VOIP) services, calendaring services, photo services, or the like. Examples of content may include text, images, audio, video, or the like, which may be processed in the form of physical signals, such as electrical signals, for example, or may be stored in memory, as physical states, for example. Examples of devices that may operate as a content server include desktop computers, multiprocessor systems, microprocessor-type or programmable consumer electronics, etc.

A network may couple devices so that communications may be exchanged, such as between a server and a client device or other types of devices, including between wireless devices coupled via a wireless network, for example. A network may also include mass storage, such as network attached storage (NAS), a storage area network (SAN), or other forms of computer or machine readable media, for example. A network may include the Internet, one or more local area networks (LANs), one or more wide area networks (WANs), wire line type connections, wireless type connections, or any combination thereof. Likewise, sub networks, such as may employ differing architectures or may be compliant or compatible with differing protocols, may interoperate within a larger network. Various types of devices may, for example, be made available to provide an interoperable capability for differing architectures or protocols. As one illustrative example, a router may provide a link between otherwise separate and independent LANs.

A communication link or channel may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. Furthermore, a computing device or other related electronic devices may be remotely coupled to a network, such as via a telephone line or link, for example.

Although there are various types of networks, wireless networks may be used. A wireless may couple client devices with a network. A wireless network may employ stand alone ad hoc networks, mesh networks, Wireless LAN (WLAN) networks, cellular networks, or the like.

A wireless network may further include a system of terminals, gateways, routers, or the like coupled by wireless radio links, or the like, which may move freely, randomly or organize themselves arbitrarily, such that network topology may change, at times even rapidly. A wireless network may further employ a plurality of network access technologies, including Long Term Evolution (LTE), WLAN, Wireless Router (WR) mesh, or 2nd, 3rd, or 4th generation (2G, 3G, or 4G) cellular technology, or the like. Network access technologies may enable wide area coverage for devices, such as client devices with varying degrees of mobility, for example.

For example, a network may enable RF or wireless type communication via one or more network access technologies, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, or the like. A wireless network may include virtually any type of wireless communication mechanism by which signals may be communicated between devices, such as a client device or a computing device, between or within a network, or the like.

Within the communications networks utilized or understood to be applicable to the present disclosure, such networks will employ various protocols that are used for communication over the network. Signal packets communicated via a network, such as a network of participating digital communication networks, may be compatible with or compliant with one or more protocols. Signaling formats or protocols employed may include, for example, TCP/IP, UDP, DECnet, NetBEUI, IPX, Appletalk, or the like. Versions of the Internet Protocol (IP) may include IPv4 or IPv6. The Internet refers to a decentralized global network of networks. The Internet includes local area networks (LANs), wide area networks (WANs), wireless networks, or long haul public networks that, for example, allow signal packets to be communicated between LANs. Signal packets may be communicated between nodes of a network, such as, for example, to one or more sites employing a local network address. A signal packet may, for example, be communicated over the Internet from a user site via an access node coupled to the Internet. Likewise, a signal packet may be forwarded via network nodes to a target site coupled to the network via a network access node, for example. A signal packet communicated via the Internet may, for example, be routed via a path of gateways, servers, etc. that may route the signal packet in accordance with a target address and availability of a network path to the target address.

In some embodiments, the disclosed subject matter may comprise a content distribution network. A “content delivery network” or “content distribution network” (CDN) generally refers to a distributed content delivery system that comprises a collection of computers or computing devices linked by a network or networks. A CDN may employ software, systems, protocols or techniques to facilitate various services, such as storage, caching, communication of content, or streaming media or applications. Services may also make use of ancillary technologies including, but not limited to, “cloud computing,” distributed storage, DNS request handling, provisioning, signal monitoring and reporting, content targeting, personalization, or business intelligence. A CDN may also enable an entity to operate or manage another's site infrastructure, in whole or in part.

Accordingly, in some embodiments, the present disclosure may be utilized via a content distribution system comprising a peer-to-peer network. A peer-to-peer (or P2P) network may employ computing power or bandwidth of network participants in contrast with a network that may employ dedicated devices, such as dedicated servers, for example; however, some networks may employ both as well as other approaches. A P2P network may typically be used for coupling nodes via an ad hoc arrangement or configuration. A peer-to-peer network may employ some nodes capable of operating as both a “client” and a “server.”

According to some embodiments, the present disclosure may also be utilized within a social network. A social network refers generally to a network of individuals, such as acquaintances, friends, family, colleagues, or co-workers, coupled via a communications network or via a variety of sub-networks. Potentially, additional relationships may subsequently be formed as a result of social interaction via the communications network or sub-networks. A social network may be employed, for example, to identify additional connections for a variety of activities, including, but not limited to, dating, job networking, receiving or providing service referrals, content sharing, creating new associations, maintaining existing associations, identifying potential activity partners, performing or supporting commercial transactions, or the like. A social network may include individuals with similar experiences, opinions, education levels or backgrounds. Subgroups may exist or be created according to user profiles of individuals, for example, in which a subgroup member may belong to multiple subgroups. An individual may also have multiple associations within a social network, such as for family, college classmates, or co-workers.

An individual's social network may refer to a set of direct personal relationships or a set of indirect personal relationships. A direct personal relationship refers to a relationship for an individual in which communications may be individual to individual, such as with family members, friends, colleagues, co-workers, or the like. An indirect personal relationship refers to a relationship that may be available to an individual with another individual although no form of individual to individual communication may have taken place, such as a friend of a friend, or the like. Different privileges or permissions may be associated with relationships in a social network. A social network also may generate relationships or connections with entities other than a person, such as companies, brands, or so-called ‘virtual persons.’ An individual's social network may be represented in a variety of forms, such as visually, electronically or functionally. For example, a “social graph” or “socio-gram” may represent an entity in a social network as a node and a relationship as an edge or a link.

In some embodiments, multi-modal communications may occur between members of the social network. Individuals within one or more social networks may interact or communication with other members of a social network via a variety of devices. Multi-modal communication technologies refers to a set of technologies that permit interoperable communication across multiple devices or platforms, such as cell phones, smart phones, tablet computing devices, personal computers, televisions, SMS/MMS, email, instant messenger clients, forums, social networking sites, or the like.

The above present persistent collaborative environment for interactive web applications provides persistence and sharing mechanisms for arbitrary application-defined objects. The sharing mechanism is coupled with a consistency mechanism that keeps client states consistent even when users perform conflicting operations. In addition, the framework maintains the interactivity of the web application at all times. The following sections provide descriptions of various embodiments of the present framework including the architecture, software and operations.

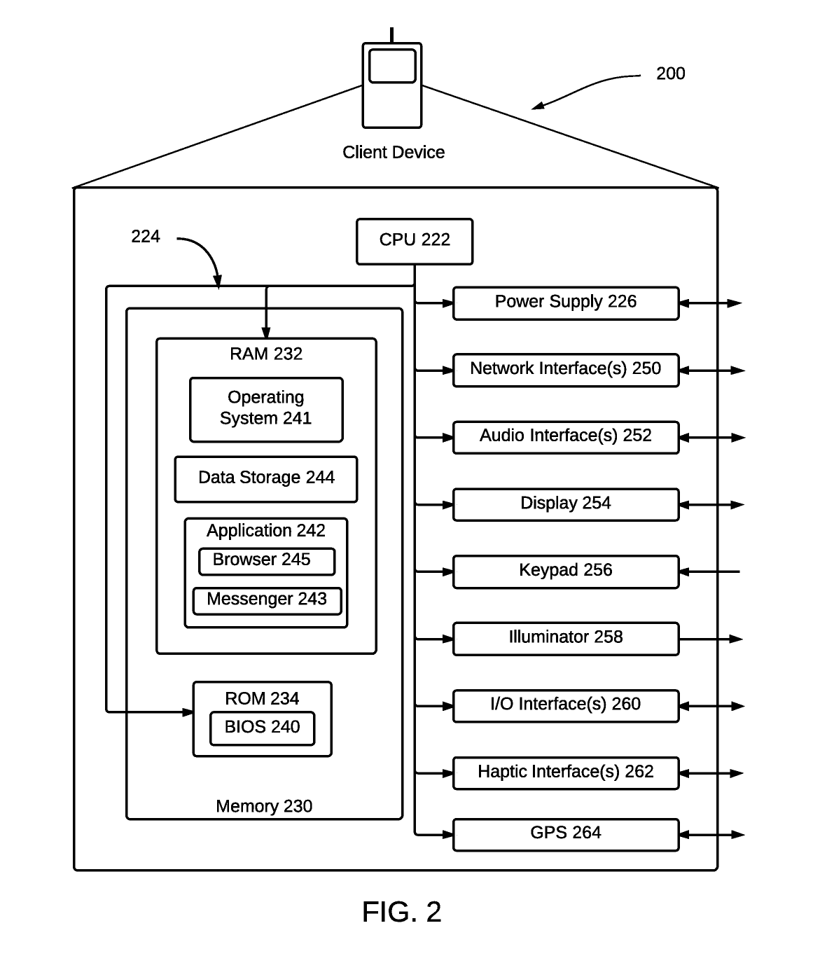

FIG. 2 depicts is a schematic diagram illustrating a client device in accordance with some embodiments of the present disclosure. As the embodiment of FIG. 2 illustrates, a client device comprises a CPU 222; a bus 224; a power supply 226; one or more network interfaces 250; one or more audio interfaces 252; display 254; keypad 256; illuminator 258; one or more input and output interfaces 260; one or more haptic interfaces 262; GPS 265; memory 230; RAM 232; ROM 234; BIOS 240; operating system 241; data storage 244; application 242; browser 245; and messenger 243.

A client device 200 may include a computing device capable of sending or receiving signals, such as via a wired or a wireless network. A client device 200 may, for example, include a desktop computer or a portable device, such as a cellular telephone, a smart phone, a display pager, a radio frequency (RF) device, an infrared (IR) device, a web enabled Personal Digital Assistant (PDA), a handheld computer, a tablet computer, a laptop computer, a set top box, a wearable computer, a game console, smart TV, an integrated device combining various features, such as features of the forgoing devices, or the like. The client device 200 includes a CPU 222 and memory 230 for storing and executing data and software. Computing devices may be provided with operating systems 241 that allow the execution of software applications 242 in order to manipulate data. A client device can be connected to the network, such as the Internet, via a wired data connection or wireless connection such as a Wi-Fi network, a satellite network or a cellular telephone network. A client device 200 can support any type of interface 250-264 for enabling the presentation or exchange of data. In addition, a client device 200 may facilitate various input means (e.g., interfaces 256, 260, 262, 252) for, but not limited to, receiving and generating information, including touch screen capability, keyboard and keypad data entry and voice-based input mechanisms. Any known and future implementations of user devices are applicable.

The client device 200 may vary in terms of capabilities or features. Subject matter is intended to cover a wide range of potential variations. For example, a cell phone may include a numeric keypad or a display of limited functionality, such as a monochrome liquid crystal display (LCD) for displaying text. In contrast, however, as another example, a web-enabled client device may include one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

The client device 200 may include or may execute a variety of operating systems 241, including a personal computer operating system, such as a Windows, iOS or Linux, or a mobile operating system, such as iOS, Android, or Windows Mobile, or the like. A client device 200 may include or may execute a variety of possible applications, such as a client software application 242 enabling communication with other devices, such as communicating one or more messages, such as via email, IMs, short message service (SMS), or multimedia message service (MMS), including via a network, such as a social network, including, for example, FACEBOOK™ LINKEDIN™ TWITTER™, FLICKR™, GOOGLE+™, to provide only a few possible examples. A client device 200 may also include or execute an application 242 to communicate content, such as, for example, textual content, multimedia content, or the like. A client device 200 may also include or execute an application 242 to perform a variety of possible tasks, such as browsing, searching, playing various forms of content, including locally stored or streamed video, or games (such as fantasy sports leagues). The foregoing is provided to illustrate that claimed subject matter is intended to include a wide range of possible features or capabilities.

A client device 200 computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

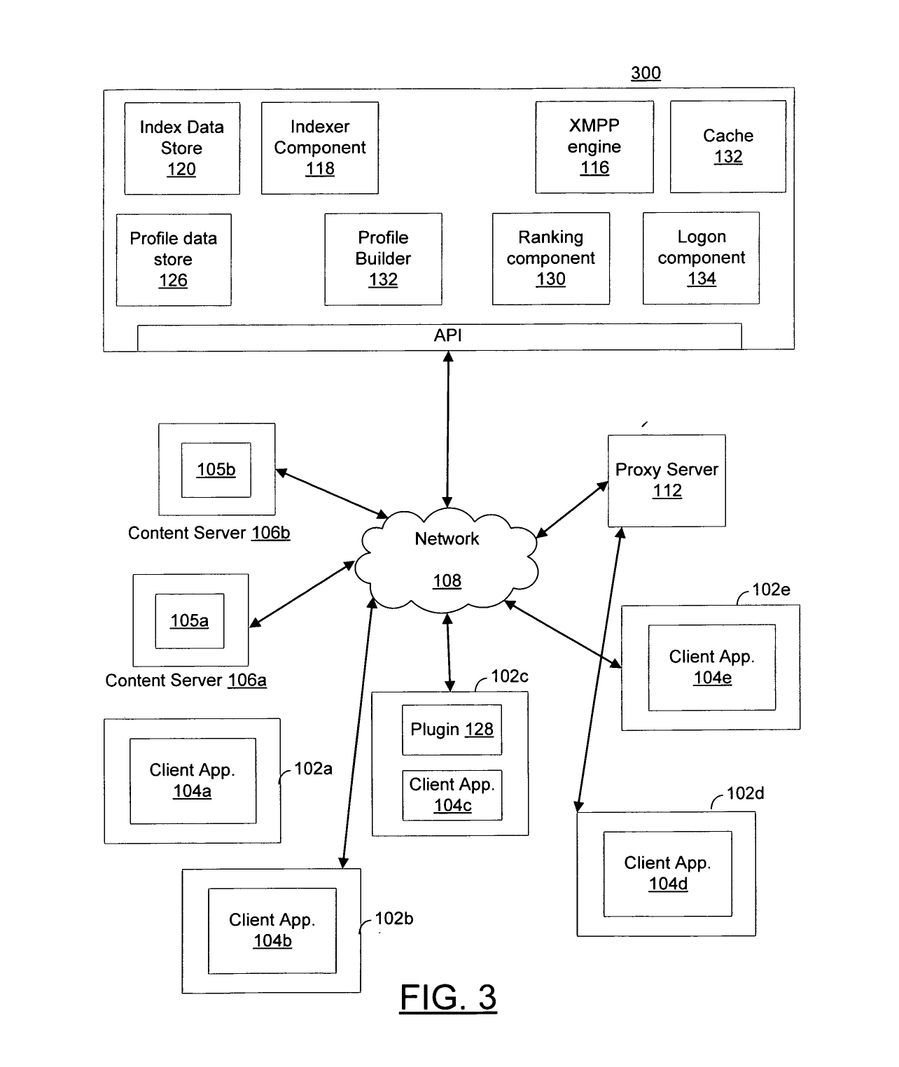

As discussed in FIG. 3, an authorization server may be accessed by a client device via one or more servers, or directly. The authorization server 300 may include several components, such as an XMPP engine (or the like), indexer, storage, query processor, and the like.

FIG. 3 depicts a schematic block diagram illustrating components of a system according to some embodiments of the present disclosure. As the embodiment of FIG. 3 illustrates a system 300 comprises an authorization server 300, network 108, content servers 106a-b, clients 102a-e, and proxy server 112. Furthermore, in the illustrated embodiment, authorization server 300 may comprise an XMPP engine 116, indexer component 118, index data store 120, profile data store 126, profile builder 132, ranking component 130, logon component 134, and cache 132. Furthermore, in the illustrated embodiment, a content server 106a, 106b may contain content 105a, 105b, respectively. Furthermore, in the illustrated embodiment, a plurality of clients 102a, 102b, 102c, 102d, 102e may comprise a plurality of client applications 104a, 104b, 104c, 104d, 104e, respectively. In one embodiment, a client 102c may additionally may comprise a plugin 128.

As discussed herein, the authorization server 300 enables communication between users. Such communication can be the form of an IM session, sharing of personal information, sharing of activity, sharing of behavior, sharing of location within the Internet or world-wide web (WWW), and the like, as will be understood from the below disclosure.

A non-limiting example of sharing of a location, or location data, may include a user notifying other users of a current web page the user is currently viewing (or has previously viewed). As discussed below, this can be understood as “checking-in” to a web site. Upon the “check-in”, a user's location on a site may be automatically transmitted to other users, or may only be transmitted upon the instant user's selection. Such transmittal can be set via predetermined preferences set by the user or authorization server. Thus, for example, user A is reading an article about the election on cnn.com. The user would like to let other users know that he/she is reading the article, so the user can select the “check-in” feature. This enables other users to know that the user is reading that article, or viewing that page at that time. Exemplary embodiments exist where only users who are “friends” with user A will receive the check-in information. The check-in information can include, and is not limited to, the user's identity, time of check-in and the URL of the web page. Other combinations and types of information can be included as one of ordinary skill in the art could ascertain. For example, the user can be afforded the ability to comment on his/her check-in prior to or after the check-in occurs and/or is transmitted to others. Also, the user can have the ability to set which users will receive the check-in data, and this may or may not be determinative upon the user's friend listing. That is, even if a user is not within the user's friend listing, the user can still communicate their check-in to another user. However, unless the other user has set an “open” check-in reception, they may not receive the unauthorized (or unknown) check-in.

The authorization server may be deployed in a distributed manner, such as via a set of distributed servers, for example. Components may be duplicated within a network, such as for redundancy or better access. An XMPP engine 316 may be operable to communicate with a variety of content or load bearing servers, and/or communicate, or coordinate communication between various clients (or users) over a network. XMPP is an open-standard communications protocol for message-oriented middleware based on XML (Extensible Markup Language). The protocol is operable for near-real-time, extensible instant messaging (IM), presence information, and contact list maintenance. Designed to be extensible, the protocol today also finds application in VoIP and file transfer signaling. XMPP uses an open systems approach of development and application, by which anyone may implement an XMPP service and interoperate with other organizations' implementations. The software implementation and many client applications are distributed as free and open source software. XMPP employs four core specifications (RFC 3920, RFC 3921, RFC 3922, RFC 3923). The XMPP Standards Foundation (formerly the Jabber Software Foundation) is active in developing open XMPP extensions.

Another aspect of XMPP is the HTTP binding for users behind restricted firewalls. Originally, XMPP could use HTTP in two ways: polling and binding. The polling method essentially implies messages stored on a server-side database are being fetched (and posted) regularly by an XMPP client by way of HTTP ‘GET’ and ‘POST’ requests. With HTTP binding, the client uses longer-lived HTTP connections to receive messages as soon as they are sent. This push model of notification is more efficient than polling, where many of the polls return no new data. Because the client uses HTTP, most firewalls allow clients to fetch and post messages without any hindrances. Thus, in scenarios where the TCP port used by XMPP is blocked, a server can listen on the normal HTTP port and the traffic should pass without problems. Various websites let people sign in to XMPP via a browser. Furthermore, there are open public servers that listen on standard http (port 80) and https (port 443) ports, and hence allow connections from behind most firewalls.

In some embodiments, an even more efficient transport for real-time messaging is WebSockets. WebSockets is a Web friendly full duplex low latency communication protocol, typically used for real-time communication between the Web browser and the WebSockets server. Similar to TCP as the transport, rich business protocols, including XMPP, can be implemented on top of WebSockets as well.

An indexer component 318 may be operable to generate an index of content 105a-b, including associated contextual content, such as for one or more databases 120, which may be utilized to locate content, including contextual content, and/or a user. An index may include index entries, wherein an index entry may be assigned a value referred to as a weight. An index entry may include a portion of the database. In some embodiments, an indexer component 318 may use an inverted index that stores a mapping from content to its locations in a database file, or in a document or a set of documents. A record level inverted index contains a list of references to documents for each word. A word level inverted index additionally contains the positions of each word within a document. A weight for an index entry may be assigned.

In some embodiments, as discussed in further detail below, as an individual interacts with a software application, e.g., a browser, an instant messenger or electronic messenger application, descriptive content, such in the form of signals or stored physical states within memory, such as, for example, an email address, instant messenger identifier, phone number, IP address, message content, date, time, etc., may be identified. Descriptive content may be stored, typically along with contextual content. For example, how an IP address or user name came to be identified (e.g., it was contained in a communication received from another via an instant messenger application) may be stored as contextual content associated with a user or the client application. Contextual content, therefore, may identify circumstances surrounding receipt of a IP address or username (e.g., date or time the information was received) and may be associated with descriptive content. Contextual content, may, for example, be used to subsequently search for associated descriptive content. As discussed below, such information may be used for advertising purposes, or other various monetization techniques.

Content within a repository of media or multimedia, for example, may be annotated. Examples of content may include text, images, audio, video, or the like, which may be processed in the form of physical signals, such as electrical signals, for example, or may be stored in memory, as physical states, for example. Content may be contained within an object, such as a Web object, Web page, Web site, electronic document, or the like. An item in a collection of content may be referred to as an “item of content” or a “content item,” and may be retrieved from a “Web of Objects” comprising objects made up of a variety of types of content. The term “annotation,” as used herein, refers to descriptive or contextual content related to a content item, for example, collected from an individual, such as a user, and stored in association with the individual or the content item. Annotations may include various fields of descriptive content, such as a rating of a document, a list of keywords identifying topics of a document, etc.

A profile builder 132 may initiate generation of a profile, such for users of an application, for example. A profile builder 132 may initiate generation of a user profile for use, for example, by a user, as well as by an entity that may have provided the application. For example, a profile builder 132 may enhance relevance determinations and thereby assist in indexing, communicating or ranking search results. A variety of mechanisms may be implemented to generate a profile including, but not limited to, collecting or mining navigation history, stored documents, tags, or annotations, to provide a few examples. A profile builder 132 may store a generated profile in profile data store 126. Profiles of users may provide a content provider or other users a mechanism to retrieve annotations, tags, stored pages, navigation history, or the like, which may be useful for monetization opportunities, such as with respect to a particular user or content revolving around activity.

Various monetization techniques or models may be used in connection with sponsored search advertising, including advertising associated with user search queries, or non-sponsored search advertising, including graphical or display advertising. In an auction-type online advertising marketplace, advertisers may bid in connection with placement of advertisements, although other factors may also be included in determining advertisement selection or ranking. Bids may be associated with amounts advertisers pay for certain specified occurrences, such as for placed or clicked-on advertisements, for example. Advertiser payment for online advertising may be divided between parties including one or more publishers or publisher networks, one or more marketplace facilitators or providers, or potentially among other parties.

Some models may include guaranteed delivery advertising, in which advertisers may pay based at least in part on an agreement guaranteeing or providing some measure of assurance that the advertiser will receive a certain agreed upon amount of suitable advertising, or non-guaranteed delivery advertising, which may include individual serving opportunities or spot market(s), for example. In various models, advertisers may pay based at least in part on any of various metrics associated with advertisement delivery or performance, or associated with measurement or approximation of particular advertiser goal(s). For example, models may include, among other things, payment based at least in part on cost per impression or number of impressions, cost per click or number of clicks, cost per action for some specified action(s), cost per conversion or purchase, or cost based at least in part on some combination of metrics, which may include online or offline metrics, for example.

A process of buying or selling online advertisements may involve a number of different entities, including advertisers, publishers, agencies, networks, or developers. To simplify this process, organization systems called “ad exchanges” may associate advertisers or publishers, such as via a platform to facilitate buying or selling of online advertisement inventory from multiple ad networks. “Ad networks” refers to aggregation of ad space supply from publishers, such as for provision en masse to advertisers.

For web portals, advertisements may be displayed on web pages resulting from a user-defined search based at least in part upon one or more search terms. Advertising may be beneficial to users, advertisers or web portals if displayed advertisements are relevant to interests of one or more users. Thus, a variety of techniques have been developed to infer user interest, user intent or to subsequently target relevant advertising to users. One approach to presenting targeted advertisements includes employing demographic characteristics (e.g., age, income, sex, occupation, etc.) for predicting user behavior, such as by group. Advertisements may be presented to users in a targeted audience based at least in part upon predicted user behavior(s).

Another approach includes profile-type ad targeting. In this approach, user profiles specific to a user may be generated to model user behavior, for example, by tracking a user's path through a web site or network of sites, and compiling a profile based at least in part on pages or advertisements ultimately delivered. A correlation may be identified, such as for user purchases or site visits, for example. An identified correlation may be used to target potential purchasers by targeting content or advertisements to particular users. Yet another approach to ad targeting could be based upon a user's current activity. Tracking of a user's path, or current location within a web site, or network of sites, and compiling of information associated with the user and/or the user's activity, or location. For example, regarding a user's activity, besides tracking which sites a user is viewing, information related to a user's activity within a site, e.g., their conversations with other users via the provided IM, provide advertisers with real-time topic points that warrant productive pivot points to provide real-time and relevant ads.

An “ad server” comprises a server that stores online advertisements for presentation to users. “Ad serving” refers to methods used to place online advertisements on websites, in applications, or other places where users are more likely to see them, such as during an online session or during computing platform use, for example.

During presentation of advertisements, a presentation system may collect descriptive content about types of content presented to users or the content being provided by the users on particular sites or via their interaction within a site/domain or network. A broad range of descriptive content may be gathered, including content specific to an advertising presentation system. Advertising analytics gathered may be transmitted to locations remote to an advertising presentation system for storage or for further evaluation. Where advertising analytics transmittal is not immediately available, gathered advertising analytics may be stored by an advertising presentation system until transmittal of those advertising analytics becomes available.

Alternatively, the system may employ advertising techniques allowing individual advertisers to target users chatting at a given domain or webpage. In this embodiment, the system 300 will allow an advertiser to monitor the chat room and “mine” chat room data for relevant key terms. For example, if users on “example.com” are discussing “Product X,” the advertiser (e.g., example.com) may present advertisements within the chat room (or in alternative embodiment, anywhere on the client device). In some embodiments advertisements may simply appear as textual “chats” optionally containing a hyperlink or other textual indicator. Alternatively, the advertisements may contain audio, video, or pictorial representations. In another embodiment, the system may allow advertisers to perform bulk analysis on past chat room logs, allowing for analytical analysis of the topics of discussion as a function of time. In another embodiment, advertisers may create interactive “bots” that interact with chat room users in manners other than simply broadcasting advertisements. In this example, an advertiser may utilize a bot that can simulate a discussion with the goal of advertising a particular product and/or assisting users in operating the website or webpage.

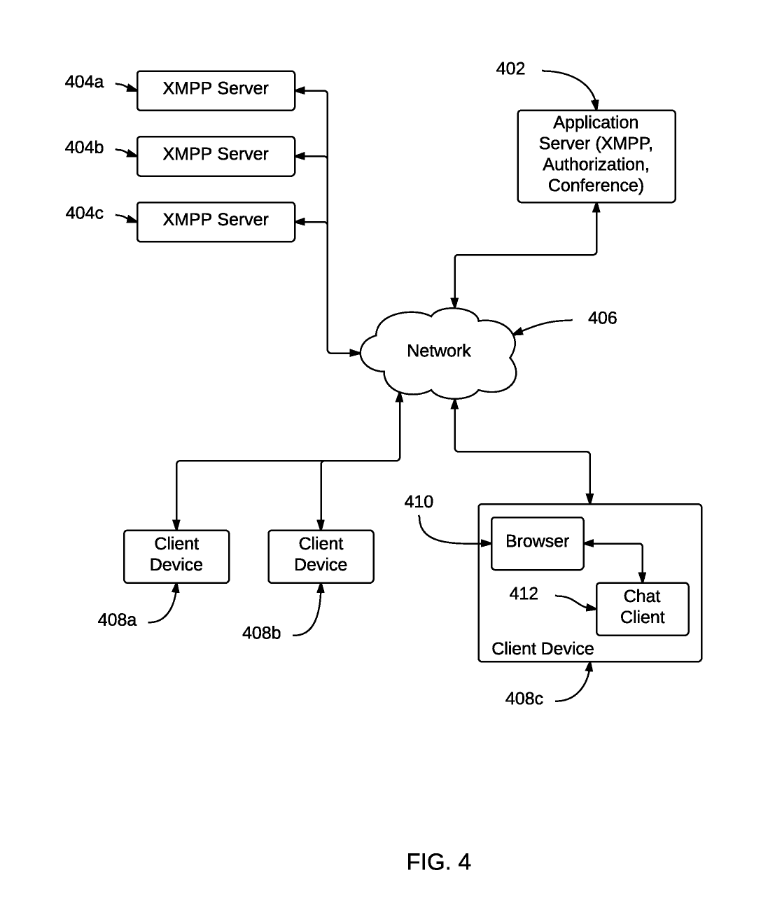

According to some embodiments, as discussed in detail below with reference to FIGS. 4-10, instant communications services can be provisioned within an online community of users such that users of the community can interact with each other using instant communications including using instant messaging (IM). A “community” refers to users within a network. For example, a community can be that of a single web site. A community can include a domain. Alternatively, a community can involve each individual sub-domain within a domain.

A service provider controls access to certain networks for terminals and users in the served community. The service provider also may determine the types of services that a user or terminal has subscribed to. A service provider includes one or more server systems that terminals (desktop and mobile units) may be linked to. Such server systems include hardware and software components that perform service provider tasks. A subscriber, through a terminal, may be logged on to a server system to establish a link to the server system. When the subscriber is logged on a server system of the service provider, he or she has an established link with the service provider over which communications between the server system and terminal may occur. When the subscriber is not logged on, the communications link is not active. Logging on to a server refers to providing some type of an identifier, usually in the form of a user name and password, to identify a user or terminal with the server so that a session can be started on the server. Thus, for example, logging on to a server of an Internet service provider allows a user (or subscriber) access the Internet.

Generally, as discussed herein, an instant communications facilitator operating from a first domain may provision instant communication services for members of an online community maintained in different domains from the first domain. According to an embodiment of the present disclosure, instant communication services may be provisioned for an online community that enable a member of the online community to exchange one or more messages with another member of the online community using an instant communication technology, such as using instant messaging (IM). The system provisioning the instant communication may be operating from a domain that is different from the domain under which the online community is maintained.

In some embodiments, state information may be stored for a user's instant communication session. The state information is then used to preserve the user's instant communication session across multiple page views or multiple browser sessions, or multiple tabs. For example, a first user interface may be displayed on a first web page accessed by a first member of an online community from a website of the online community. The first user interface may enable the first member to exchange messages with another member of the online community. In one embodiment, when the first member accesses a second web page (i.e., a different pageview) from the website of the online community provider, the same first user interface is displayed. This can be performed based upon the state information stored for the user. Various different pieces of information may be displayed in an instant communication user interface displayed for a user. The displayed information may include presence information for the user or friends of the user, or other users within the same domain, site or network, status information for the user, or friends of the user, or other users within the same domain, site or network, one or more notifications received by the user, and other like information.

In one embodiment, a set of application programming interfaces (APIs) is provided for facilitating exchange of information between a community provider system and a system facilitating the instant communications. For example, a first set of APIs may be provided by the community provider system that is callable by the system facilitating the instant communications. A second set of APIs may be provided by the system facilitating the instant communications that are callable by the community provider system. In one embodiment, the same system may facilitate instant communications for multiple online communities, such as for a first online community operating from a first domain and a second online community operating from a second domain different from the first domain. The system facilitating the instant communications may be operating from a third domain that is different from the first and second domains.

In one embodiment, for a user who is a member of the first online community and the second online community, the user may have a first list of friends for the first online community and a second list of friends for the second online community. In some embodiments, an aggregated list of friends may be displayed on a first web page accessed by the user from a website of the first online community. The aggregated list of friends may include one or more friends in the first list of friends and one or more friends in the second list of friends. Indeed, the user on a first domain also has the ability to communicate with users' who are not within a friend listing. That is, if a two users are within the same online community, for example reading the same article on a web site, they will have the ability to communicate with one another, as discussed in more detail below.

The foregoing, together with other features and embodiments will become more apparent based on the below discussion of FIGS. 4-10. The present technique employs a server-client based scheme. The web application respectively runs on a client associated with each user. A client-side library on each client interfaces with the application and communicates with a server. For the purposes of this summary and the description to follow, the term client will be used to mean the client as a whole including both the client application and the client-side library. In some instances it is appropriate to note whether the client application or the client-side library is responsible for a specific action. In such cases, the application or library will be called out specifically.

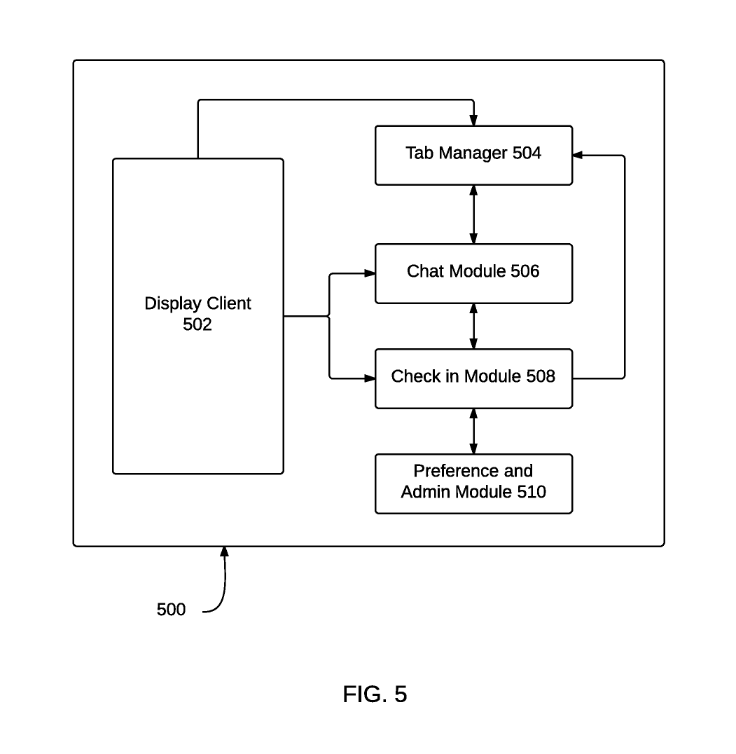

As illustrated in FIGS. 4-5, the environment for the present disclosure will be discussed in more detail. The server 402 is generally charged with managing chat and chatroom creation and flow as well as user logins and disconnects. In addition, the server 402 is involved with persisting changes to the application received from the client-side library of the individual clients 408a-c, and maintaining consistent application state across all the clients 408a-c. As indicated previously, this replication, persistence and consistency maintenance are accomplished independent of the application.

More particularly, in one embodiment of the present framework each client device 408a, 408b, or 408c first sends a request to the server 402 to log into a session of the web application. This request generally includes the user's name or chat identifier and identifies the session the user wants to join. The server 402 determines if the request is valid and from an authorized client 408a, 408b, or 408c, and it checks to see if the desired session will be a new one or an ongoing one. If it is a new one, the server 402 creates the session using a user/application-specified name. The server 402 then sends the client-side library of the requesting client 408a, 408b, or 408c both a client identification token and session token. The client identification token uniquely identifies the client and the session token identifies the session. These tokens are included in all future communications from the client to the server, so that the server will know what client and what session the communication concerns. The client-side library next sends an initial update poll to the server requesting an update to place the application running on the client in a current state in accordance with the user's present activity on the network. This initial update poll also includes a timestamp and location information. In response, the server sends the polling client-side library a set of information that defines the current state of the application and provides information regarding other activity on the network (or at the site the user is viewing, or other information requested by the user, e.g., friends activity from other sites).

Once a client 408a, 408b, or 408c is logged on and its application is updated to the current state, each time a change is made to a property of one of the objects of the application that the application wants to persist and/or share, the client application generates information defining the change and the client-side library sends it to the server. It is noted that the application running on the client implements the change immediately. Server permission is not required.

Periodically, the client-side library sends an update request to the server requesting an update to the state of the application. This request includes the last cached timestamp, as well as the aforementioned tokens which provide the user's relevant information, including, but not limited to the user's current status on a site/network and activity within the site or IM. In response to an update request received from the client-side library, the server returns information that were persisted after the time represented by the received request, or which were not previously sent to the library but have become available for dissemination. In addition, the server includes an updated timestamp. Note: while the foregoing limitations in existing interactive web applications described in the Background section can be resolved by a particular implementation of a persistent collaborative framework for interactive web applications according to the present disclosure, this is in no way limited to implementations that just solve any or all of the noted disadvantages. Rather, the present framework has a much wider application as will become evident from the descriptions to follow.

The server 402 can be a typical of web server which processes new server instances at each service request from a client 408a, 408b, or 408c. As a result, the server 402 instances do not maintain any state in memory. Instead, a database coupled to the server can be used to store client updates, while the caller of the service is responsible for maintaining any context the server 402 includes in the response. For example, such context includes login tokens, which the server 402 sends in response to login calls. These tokens help a future server process recognize a client 404. To remove the burden of maintaining such context from the web application programmer, the present framework provides a client-side library for each client 408a, 408b, or 408c to maintain this context, as discussed above. Thus, for example, the client-side library would include the aforementioned client identification token with all data sent to the server 402, so that the server can recognize the data as coming from a legitimate client 408a, 408b, or 408c. Each client 408a, 408b, or 408c also has a copy of a browser 410 and chat client 412, which interacts with the server 402. The browser 410 and chat client 412 expose an API, which includes function calls for login and logout, persisting and sharing updates, and communicating over a network.

The server 402 persists and shares data on a per session basis. Thus, each client 408a, 408b, or 408c, must either create a new session or log into an existing one. Each session is assigned a name, which can be user/application provided, implicitly inherited from a URL associated with the client, or established in some other appropriate manner. Regardless, if the session is new, the server 402 creates a new session. On the other hand, if the session was previously created, then the server 402 assumes that the user wants to load the current data for the session. The server 402 sends session tokens, which like the login tokens, are a part of the context cached by the client-side library, and included in data sent to the server so that the server can identify the session to which the data applies. The client can make asynchronous web-service calls to the server 202 so the user is never blocked waiting for a response from the server. Thus, when a user performs an action, the result is immediately shown to the user, even though the server may not have processed it yet. In addition, as the updates are property-based (as will be described shortly), the controlling program can process updates when it receives them without the full page refreshes typical of past web applications.

The server 402 sends updates to the client 408a, 408b, or 408c that were made by a user associated with each of the other clients. Because the interactive application is web-based and HTTP is a connection-less protocol, there is no easy way for the server to push information to the client. As a result, the client, via the controlling program, is responsible for sending periodic requests the server requesting available updates.

By hooking into the client 408a, 408b, or 408c running the controlling program through a minimal API set, web application developers can focus on developing the business logic and the application UI. In particular, the web application developers do not have to worry about managing communication between the client and the server or between different clients and different servers. Moreover, the server provides all session persistence, so this need not be dealt with at the application level. Finally, the application developer does not have to worry about maintaining a consistent state across the clients 408a, 408b, or 408c, this is handled by the server and client-side controlling program loaded with each client's browser.

As illustrated in FIG. 4, the system may allow for the communication with multiple, third-party XMPP servers 404a, 404b, 404c or other servers utilizing chat technology. This allows the system to enable users to utilize existing chat accounts (e.g., GOOGLETALK or YAHOO! MESSENGER) to communicate within the present system.

As illustrated in FIG. 5, the client device may connect to the Internet via a communication interface over a transmission media. The communication interface facilitates two-way communication between the device and another electronic device or system, e.g., a server computer provided by a content provider. An Internet user using the client device may gain access to the Internet by causing a browser to execute, thereby opening a communication link between the communication interface of the device and an Internet site of a content provider, via an Internet Service Provider (ISP). The browser running on the client device provides, to the device's display, a browser interface having a layout (e.g., color, size, number, location) and functionality of windows and tabs. Internet content is communicated by the content provider to the device for display in a content window of the browser interface.

The browser configured in accordance with various embodiments of the present disclosure includes an interface object that is defined by the ActiveX control or other Plug-in loaded in the library file by the content provider. The interface object comprises a pull-down menu and is displayed in the browser toolbar with the interface controls (i.e., browser toolbar objects) provided by the browser. An interface object comprises an interface object toolbar and a pull-down menu displayed within the browser interface. An interface object comprises an interface toolbar, docked or undocked UI or moveable UI including a plurality of pull-down menus and a search window displayed within the browser interface. An interface object, in accordance with the various embodiments of the present disclosure, may comprise virtually any type of information and/or functionality available via a browser. Thus, by way of non-limiting example, an interface object may comprise a pull-down menu, a toolbar and a pull-down menu, textual information (e.g., advertisements, coupons, etc.), textual and/or aural information (e.g., a textual advertisement with accompanying sound), textual, aural, and/or graphical (animated or not) information, video, video and audio, audio, etc.

A controlling program which is provided by a content provider (via the authorization server), and when executed by an Internet user, provides that user with the ability to thereafter control that user's Internet browser interface, as discussed in more detail below. The controlling program, downloads or creates a library file on the Internet user's device that includes ActiveX control or Plug-in code that define an interface object. Each time the Internet user activates the browser, the library file is opened and a connection can be established with the authorization server. The authorization server can automatically establish a connection to an Internet web site the user is currently viewing. The open library file essentially provides a shell within the browser within which the functionality provided by the ActiveX control or Plug-in may be added to the browser interface. Neither the library file nor the shell close until the browser is closed. However, the connection with a site, or other users' may be controlled according to the user's predetermined configurations, or in accordance with presets set by the authorization server. The information and/or functionality of the interface object is defined by the ActiveX control or Plug-in. In accordance with the various embodiments of the present disclosure, the interface object remains displayed by the browser with the browser interface, for as long as the user continues to surf the web, i.e., as long as the browser is activated. Thus, the functionality added to the browser and browser interface in accordance with the present disclosure is not lost as the Internet user surfs the web.

FIG. 5 depicts a browser environment according to some embodiments of the present disclosure having a display client 502, tab manager 504, chat module 506, check-in module 508, and a preferences/admin module 510. As illustrated, the display client 502 is operative to display webpage data as well as third-party data such as extensions and other browser add-ons. The tab manager 504 is operative to communicate with the browser and display client and maintains a record of tabs and URLs associated with each tab and new browser window. Tab manager 504 is also operative to communicate these records to the chat module for coordination of messages received from the chat server. Chat module 506 is further operative to load and display a graphical user interface for allowing the presentation of chat messages for a given webpage or domain. Check-in module 508 is operative to receive webpage and domain data from display client and allow a user to check-in to a given domain and/or webpage, as discussed previously. Preferences and admin module 510 is operative to provide an interface that allows the user to change options such as username/password information as well as application information (such as automatic logging in etc.).

The controlling program, running on the user's device and within the user's initiated browser, e.g., as a browser extension enables the user to communicate with other users over the network. The controlling program therefore extends the functionality of a web browser. Depending on the browser and version, the extension may be referred to as a plug-in or add-on. The syntax of extensions may be different from browser to browser; however, for purposes of this disclosure, the applicability of the controlling program produces the same result. The ability to communicate is enabled via a user-login. The user has the control to initiate the ability to communicate, and/or receive communications during a browsing session. Therefore, despite the controlling program running, a user has the ability to surf the web without interruptions from other users on a site, and or “friends” also browsing the web.

The system 500 may also provide a tab manager 504 which enables the user control differing browsing sessions. Differing sessions can be coordinated via the controlling program to provide a synchronized IM session for the user. Therefore, a user can have multiple IM/check-in sessions within a single browser. For example, if a user has two tabs open, and is viewing web page A and web page B, the two differing IM/check-in sessions can be running so that the user is able to communicate with relevant users and provide relevant information/communications between differing communities.

The system 500 may also provide the user, as discussed above, the ability to check-in via a check-in module/engine. A check-in, for purposes of this disclosure, relates to a user de-marking their position within a network at a particular site, as discussed above. A check-in can be communicated to other users. The communication of a check-in can be manual, via user selection to transmit the check-in to selected users, or automatically. Embodiments exist where the user will only be afforded the ability to engage in an IM session within a community upon checking-in to the particular site/domain/community.

According to some embodiments, the system 500 can generate a separate browser window so that communications affiliated with an existing window can be properly viewed and managed by a user and/or the device. For example, should a user being implement the controlling program on a mobile device, or even a tablet, a separate browser window may be initiated. This enables the user to properly and efficiently communicate with other users while still maintaining the viewability and rendering ability of the existing browser instance.

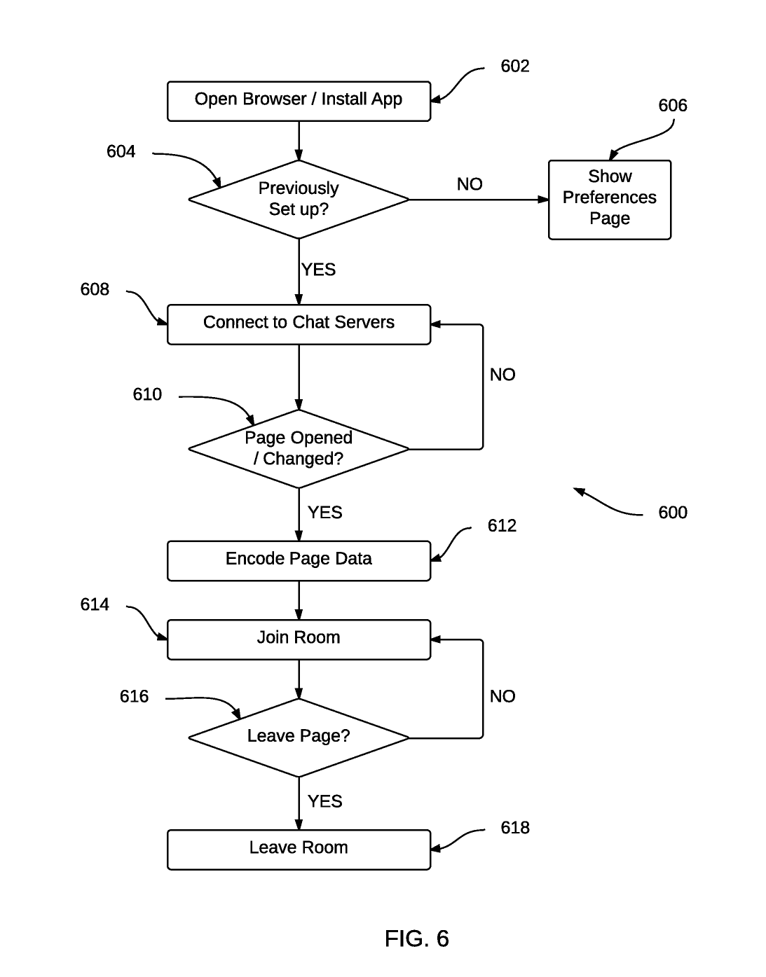

FIG. 6 is a flow diagram illustrating steps performed in accordance with some embodiments of the present disclosure. In the embodiment that FIG. 6 illustrates, a method 600 opens a browser or installs an app, step 602. The method 600 then determines if the application has previously been setup, step 604. If not, the method 600 shows the preference page, step 606. In one embodiment, installing an app comprises installing a browser extension. In one embodiment a preference page allows the user to change options such as username/password information as well as application information (such as automatic logging in etc.).

If the application is setup, the method 600 connects to the chat servers, step 608. In one embodiment, connecting to chat servers is accomplished via XMPP. The method 600 then determines if a page is opened or has changed, step 610. If not, the method 600 continues to be connected to the chat server, step 608. If the page is opened or has changed, the method 600 encodes page data, step 612, and joins a room, step 614. In one embodiment, encoding page data comprises maintaining a record of tabs and URLs associated with each tab and new browser window. The method 600 then determines if the page is left, step 616, and if not, continues to remain in the room, step 614. If the method 600 determines that the page has been left, the method 600 then leaves the room, step 618.

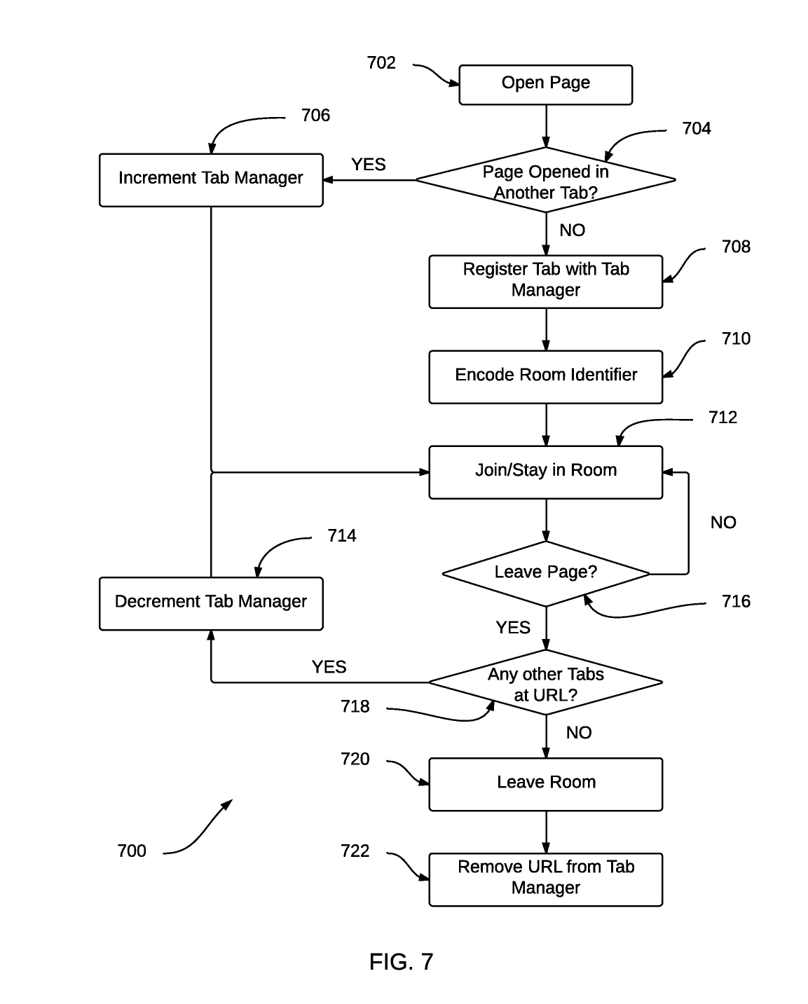

FIG. 7 is a flow diagram illustrating steps performed in accordance with some embodiments of the present disclosure. In the embodiment that FIG. 7 illustrates, a method 700 opens a page, step 702. The method 700 then determines if the page is opened in another tab, step 704. If the page is opened in another tab, the method 700 increments a tab manager, step 706. If not, the method 700 registers the tab with the tab manager, step 708, and encodes a room identifier, step 710. The method 700 then joins or stays in the room, step 712, and determines if the page is left, step 716. If the page is not left, the method 700 continues to stay in the room, step 712. If the page is left, the method 700 first determines if any other tabs are at the URL, step 718. If tabs are at the URL, the method 700 decrements the tab manager, 714, continues to stay in the room, step 712, and does so until the method 700 determines if the page is left, step 716. If there are no other tabs at the URL, the method 700 leaves the room, step 720, and removes the URL from the tab manager, step 722.

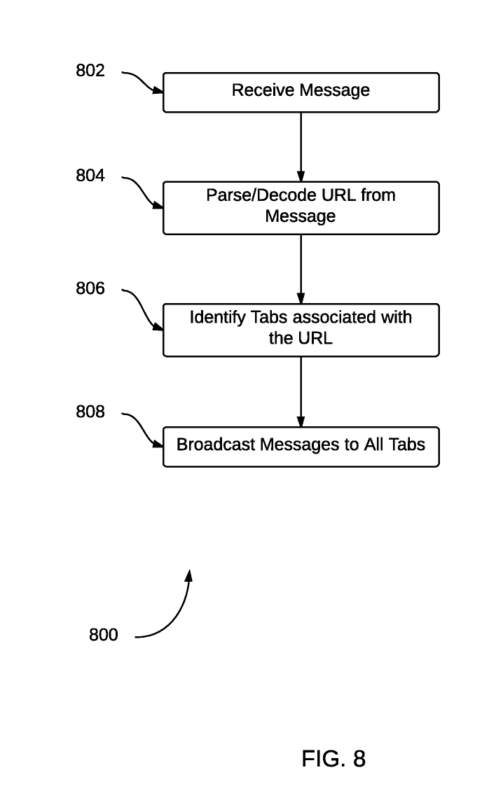

FIG. 8 is a flow diagram illustrating steps performed in accordance with some embodiments of the present disclosure. In the embodiment that FIG. 8 illustrates, the method 800 receives a message, step 802. The method 800 then parses/decodes a URL from the message, step 804. The method 804 then identifies tabs associated with the parsed/decoded URL, step 806. Finally, the method 800 broadcasts the received messages to all the identified tabs, step 808.

As illustrated in FIGS. 6-8, a user associated with a client device may connect to start a session with a website of a community provider system. As discussed above, during the session, the user may access one or more web pages served from the website of the community provider system, step 702. For example, a user may use an application such as browser executing on user system to log onto and open a session with a website of a community provider system and access one or more web pages served by that website. Examples of commonly used browsers include Windows Internet Explorer, Mozilla Firefox, Apple Safari, Google Chrome, Opera, and others. A user may request a web page by providing a uniform resource locator (URL) corresponding to the web page to the browser or by clicking on a link in a web page. The requested web page corresponding to the URL or the clicked link is then fetched and output or rendered to the user by the browser.

For example, a user using a browser executing on user system may access web pages served by a web server. The user, upon viewing these pages becomes a member of the web page's community, steps 614, 712. After becoming a member of the community A (e.g., viewing a web page), the user may identify a subset of members of the community. In some embodiments, as discussed below, the user may be able to identify other users and/or friends who are respective of such community. In some embodiments, the number of users may be visibly displayed to the user respective of the number of users and/or number of friends. In other embodiments, the listing of users names or other forms of IDs may be displayed. The user may then interact with the user's friends and/or other users within the community. A list of friends of the user is commonly referred to as the user's friend list (or buddy list). Information related to a user's friend list may be stored as part of community members' profile or information. The user may add friends or delete previously identified friends as desired.

According to the embodiment depicted in FIG. 7, a user may be a member of multiple online communities via different browser sessions (or windows) or different tabs within a single browser session, as discussed above. For example, a user may be a member of community A within tab 1 of the browser, and a member of community B within tab 2 of the browser. For example a user may be viewing an article on cnn.com within one tab, and viewing an article on swagbucks.com within tab 2. The user may have a friend list specific to each online community. Accordingly, the user may have one friend list for community A and another friend list for community B. In this manner, a user may be a member of several online communities with a friend list specific to each community identifying a subset of members of that community.

According to some exemplary embodiments, a listing of users currently residing within a respective community can be provided. This affords the user the ability to engage in communications with users who share a common interest. This also affords the user the ability to meet and interact with users in a way that typical social networking fails to provide. That is, user's have the ability to interact with users who are unknown to the user, or for which they do not share an established relationship.

According to an embodiment of the present disclosure, the controlling program is configured to provision instant communication services for users (members) of one or more online communities. Members of a community can be designated to user's who have checked-in or users who have merely visited a site. In this manner, the controlling program provides and enables instant communications for users of multiple online communities. Since the instant communication capabilities are provided by the controlling program via the authorization server and API server(s), a community provider does not have to itself invest in or host an infrastructure for providing instant communication capabilities for its members. The instant communication services are outsourced and separate from the interne sites/domains the user's are visiting.

The community program can operate under its own domain (via the API server(s)) that is different from the domains of the community provider systems for whom the instant communication capabilities are provided. From a user's perspective, the fact that the instant communication services are being hosted by a third-party facilitator rather than the community provider system is transparent to the user, meaning that a user cannot detect any difference between a community provider system-hosted instant communication solution and an instant communication solution.

Since the system facilitating instant communication services and the system maintaining the community of users for which the services are provisioned operate under different domains, special techniques are used for communication of information between provider systems. As discussed above, API servers running XMPP can be utilized. As is known in the art, cross-domain XHR (XmlHttpRequest) requests is a practice called ‘jsonp’ (json with padding). A scripting language such as JavaScript running in the context of domain A in the user's browser makes a script tag request to a URL on domain B with the data for the request and the name of a function referred to as the callback function. The server response contains a JavaScript expression that calls the callback function with the response data as the argument to the callback function. Since the call was initiated using a script tag, the browser evaluates the response, executing the callback function with the response data. The browser then evaluates the response, calling processCommand with ‘Hello’ as the first argument. This method, however, does not work for POST requests. The common method for cross-domain POST requests is to submit the POST using a form with an IFRAME target. Since the IFRAME loads the response data in a cross-domain container, the JavaScript making the request cannot access the response data. In one embodiment, this problem is overcome by creating a long-polling cross-domain GET request to a backend session (referred to as the eventsloop) using that as a channel upon which responses can be returned. A long-polling request is a request that does not return a response until data is available or a minimum amount of time has elapsed, whichever comes first. When the JavaScript wishes to make a cross-domain XHR POST request, it adds a requestid parameter to the request. This is a signal to ICFS that the response should be sent over the eventsloop along with the given requestid (to give the JavaScript the correct context). Accordingly, JavaScript running in the context of domain A makes a long-polling eventsloop GET request A1 to domain B. It then sends a POST request A2 to domain B (e.g., to Chat server). The response to the GET request A1 from domain B contains the response to request A2.

In some embodiments, the cross-domain communication problem can be avoided by having the community provider system create a DNS record as a subdomain of their main domain pointing to API servers. This avoids the cross-domain rules. This however substantially increases the complexity of the deployment for the community provider system. This solution is also not very scalable. It should be noted that the jsonp and requestid implementations are not necessary with recent browser technology. Current browsers support cross-origin messaging through a postMessage method which allows frames on separate domains to communicate securely within the browser. Many browsers also support cross-domain XHRs directly. A large population of users however continues to use older browsers that do not have support for these technologies. In one embodiment, the technique used for cross-domain communications is selected based on what the browser supports. For newer browsers, the new methods may be used, while for old browsers the jsonp method described above may be used.

According to some embodiments, the API (application programming interface) servers provide a system to communicate and exchange information with each other to enable the instant communication services. The Web Service APIs comprise a set of Web Service APIs provided by the community provider system and a set of Web Service APIs provided to get information from or post information to a community provider system. Such APIs may also include APIs that may call to cause the community provider system to perform an operation. Processing related to handling of APIs is performed by API servers present in the community provider system. Thus, API servers are configured to interact and exchange information with a community provider system using a set of Web Service APIs. Requests can be made to them by any of the other party's servers.

As depicted in FIGS. 4-5, the communication system may also comprise an instant communication infrastructure that implements instant communication sessions for a community of users. For example, instant communication infrastructure may support IM chat sessions between members of a community. Instant communication infrastructure may comprise one or more IM gateways and one or more chat servers (e.g., Jabber servers) that facilitate the chat sessions. For example, a community provider system may provide the instant communication infrastructure. In such an embodiment, the instant communication infrastructure of the community provider system may be used for supporting instant communication among members of the community provider. In such an embodiment, the controlling program may connect to the community provider system and use them as the conduit for delivering IMs. A user member of the community provided by the community provider system may be authenticated (e.g., using a username and password as described below) and a friend list may be retrieved for the user, but in order to send a message, the controlling program sends it to the community provider system's IM network servers.

As described above, the extension (or controlling program) enables instant communication sessions between user members of a community. Instant communication session status information stored for a member of a community may comprise information such as: (a) status information for the member (e.g., available, busy, etc.), which describes the manner in which a user is online (This can include, for example, status messages); (b) presence information for the member including information indicating whether the member is online or offline, or the user's activity on a network or community; (c) information related to messages sent by or received by the member; (d) information related to notifications received by the member; (e) a session ID for the user; (f) information related to the user's friends including status of the friends; (g) the user's profile information such as information about the user, the user's name, a photo/icon to be displayed for the user, etc.; and (h) other information related to the member user's session (e.g., such as other user's information for which they have been communicating). The session state information can be used by authorization server to preserve the state of a user's instant communication session across multiple page-views served to the user from the website of a community provider system.

According to some embodiments, code that is associated with web pages served by an online community provider system comprises a piece of JavaScript that is added to pages served from the website of the community provider system. An HTML file that is used by the JavaScript code is also placed in a location accessible to the JavaScript code. The HTML file may be placed on a web server of the community provider system or alternatively may be placed on authorization server. In an embodiment, JavaScript code is associated with web pages. The code may be placed immediately after the <body> tag of the web page. This is done so that the JavaScript has ample time to load while the web page loads simultaneously. By loading the code simultaneously and asynchronously, the impact of loading the code on the web page is minimized.

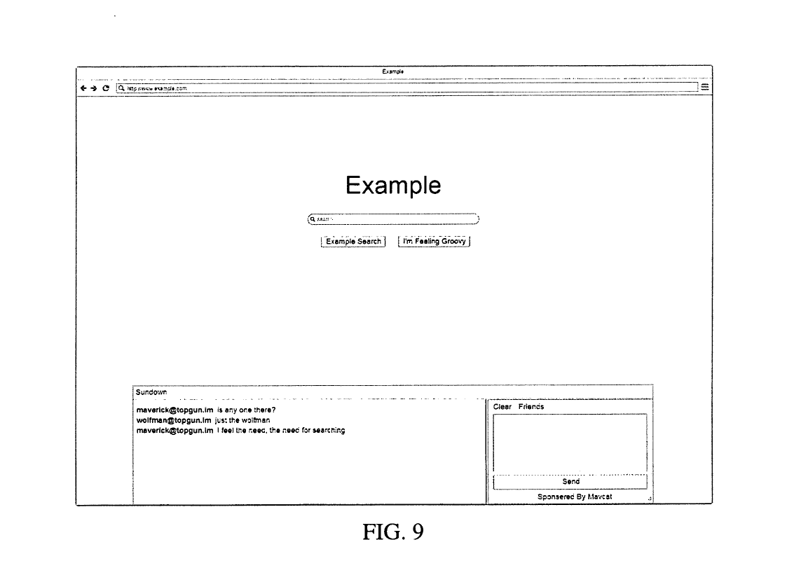

Once the JavaScript code has loaded on a web page served from a website of a community provider system, it creates a user interface (the user interface that enable instant communication, e.g., instant communication user interface (UI) depicted in FIGS. 8-9 and described below) also defines a set of APIs (JavaScript APIs) for the webpage to interface with, creating new functionality that is better integrated with the user experience. For example, the web page may display a list of members of the community that when clicked will call a JavaScript API to create an IM window to start talking to that user. As discussed herein, the users within the community can be that of users for which the instant user has a relationship prior, or users who are visiting the same domain, or site/web page within said domain. That is, the communications can be at a domain level, or independent for each sub-domain. This enables a user to interact with the chat system by interacting with the web page. The web page can essentially call JavaScript API's to start a conversation; share content such as photos, videos, text, and links; configure the user interface by enabling or disabling features; and so on. The JavaScript APIs allow JavaScript code on the webpage from a community provider system running in the browser to interact with JavaScript code running in the same browser. The APIs allow the community provider web page to perform actions such as opening an IM window or sharing content when a user clicks on parts of the partner page. While the embodiment described above uses JavaScript, in alternative embodiments, the code associated with a web page may be in any other language, including any scripting language.

FIGS. 7-8 provide a high level depiction performed at runtime for enabling instant communications between users in accordance with an embodiment of the present disclosure. The methods 700 and 800 depicted may be performed by software (e.g., program, code, instructions executed by a processor), in hardware, or combinations thereof. The software may be stored on a computer-readable storage medium. Runtime processing may be initiated when a user, who is a member of a community, uses an application such as a browser executing on a user system to request a web page from a website of a community provider system. The user may request the web page by providing the URL for the web page to the browser, step 702. Alternatively, the web page may be requested as a result of the user clicking on a link on another web page already loaded by the browser. The web page requested by the user is then served to the user system from the community provider's website. The browser executing on the user system then loads and displays the received web page. Several processing steps are triggered by the loading of the web page. As a result of the loading, the special code (for example, JavaScript code) associated with the web page is executed and causes code to be loaded that enables instant communication services, steps 704-712. As described above, in one embodiment, loading of the code on a web page served from a website of a community provider system creates a user interface (the user interface that enable instant communication, e.g., instant communication user interface) also defines a set of APIs (JavaScript APIs) for the webpage to interface with, creating new functionality that is better integrated with the user experience.

The user requesting the web page is then authenticated to determine whether instant communication capabilities are to be provisioned for the user, see e.g. steps 604-606. Upon successful authentication, an instant communication session is enabled for the user and a user interface that enables instant communication capabilities for the user is rendered on the same web page that is displayed to the user. In one embodiment, a user interface such as the user interface depicted in FIGS. 8-9 and described below is displayed to the user.

In some embodiments, the user information is stored on the user system by the community provider system when the user successfully logs on to the website of the community provider system. The user information may be stored in the form of a cookie on the user system. When a user ends the session with the community provider website (e.g., when the user logs out from the community provider website, the cookie stored on the user system is cleared).

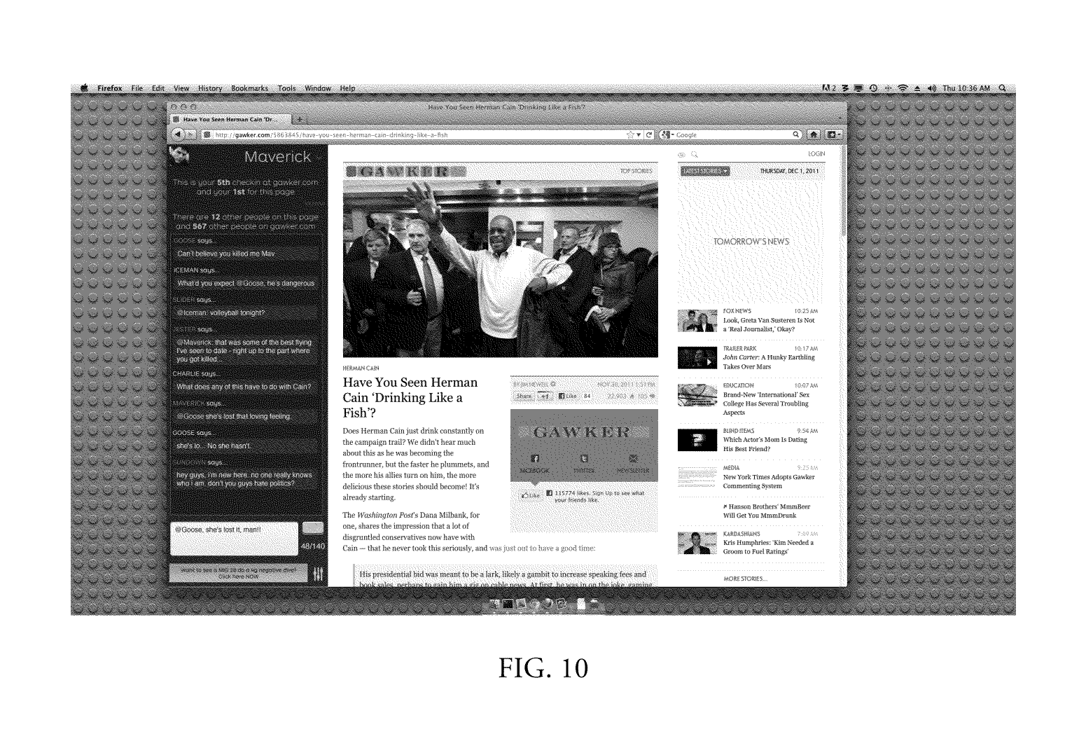

As depicted in FIGS. 9-10 as non-limiting examples, a user interface (UI) that enables instant communication capabilities for the user to be rendered on the web page accessed by the user is displayed. In one embodiment, the user interface is overlayed on the web page displayed to the user. In this manner, the user interface for enabling instant communications is displayed on the same page served to the user from the community provider system. In one embodiment, the user interface comprises a bar comprising tools and showing status of the user's instant communication session. The user's friend list received in may also be displayed as part of the user interface.

FIGS. 9-10 depict non-limiting examples of an instant communication user interface that may be displayed for a user to enable instant communication services for the user. A browser executing on a client device displays a web page served from a website of a community provider system. The URL corresponding to the displayed web page is displayed by browser. An instant communication user interface that enables instant communications for the user is also displayed on web page. The user interface comprises a first section comprising a set of content sharing tools. The content sharing tools may include user-selectable tools that enable content from the displayed web page, or the web page itself, to be shared with other members of the community. Such tools may include a check-in feature, as discussed above. The UI comprises a second section that shows the status of the user's friends in the online community. The UI can also comprise a listing of other users currently visiting the same web page. The user has the ability to preset preferences (which can be stored in their profile) so that the user is able to predetermine whether they would like to view the users currently visiting a page at the domain level, or at a sub-domain level particular to the page they are currently viewing.

Further, presence information and status information can be displayed for each user. Presence information may indicate which web site the user is viewing an other types of activity (e.g., check-in information). In one embodiment, for each instant communication session for a user, presence information and status for the user can be stored. Status information may be set by to reflect the user's status such as “available”, “busy”, or personalized statuses, and the like. The API servers can convey information about the status of the user's friends and/or other users within a community.

A user may decide to open a chat session with one or more users displayed in window. In one embodiment, the user may open a chat session with a user by clicking on the user's name in the UI. According to some exemplary embodiments, a chat session can embody that of a chat room, whereby all users within a community have an open forum to communicate. In this instance, a user merely engages in communications (or IMs) by entering text. According to some embodiments, sub chat rooms may be available so that interested users can independently engage with each other separate from the community chat room.

In an example, in accordance with some embodiments, a UI is rendered on a web page “WebPage_{—}1”. The user may subsequently access another web page served from the website of the community provider website. For example, the user has accessed “WebPage_{—}2” served from the website. WebPage_{—}2 may be rendered in another browsing window, or in a created tab within the initial browsing session. According to some embodiments, based upon the instant communication session state information stored for the user, the instant communication user interface that was rendered on WebPage_{—}1 can also be rendered on WebPage_{—}2. In this manner, the state of the instant communication user interface is maintained across multiple page views. The multiple page views may be pages that are sequentially accessed by the user or multiple pages that are concurrently loaded by the browser in different tabs. Accordingly, the session state information is used to preserve the state of a user's instant communication session across multiple page-views served to the user from the website of a community provider system. The session state information may also be used to synchronize state between sessions on separate computers. In some alternative embodiments, should a user visit WebPage_{—}2, a separate UI session would be created, where that UI session would be independent of the WebPage_{—}1 session, and based upon the activity, users and content relevant to WebPage_{—}2.

As discussed above, the community provider system sites may choose to allow users to communicate with other users who are not friends of the users. If so, users may wish to add friends when chatting with them. The controlling program may provide a button in the IM window when a user is chatting with a non-friend to allow them to send an add friend request. The community provider system can then use the information to generate an add friend request to the other user, or if the other user has already sent an add friend request, the community provider system may choose to treat it as an approval of the add friend request. This API call is only a request for a friendship (or create an established relationship).

According to some embodiments, the controlling program can display friends and provision an instant communication session for a community provider system with or without the user being on the site at the current time. In some embodiments, instant communication sessions with traditional IM networks such as AIM, GoogleTalk, etc may also be available. In this instance, the controlling program's UI can aggregate all of the chats for a user within a single UI. (As discussed above, chats within different communities may also be aggregated across domains/communities.) This enables the user to exchange IMs with other users across chat platforms (and across UI sessions via the controlling program) from within a web page served from a web site of one of the communities. Thus, the notifications can be displayed in the same window. In some alternative embodiments, notifications received from user's respective of differing communities may be displayed in separate windows from the window displaying the instant IM session respective of the site the user is visiting (and the site the browser is currently displaying).

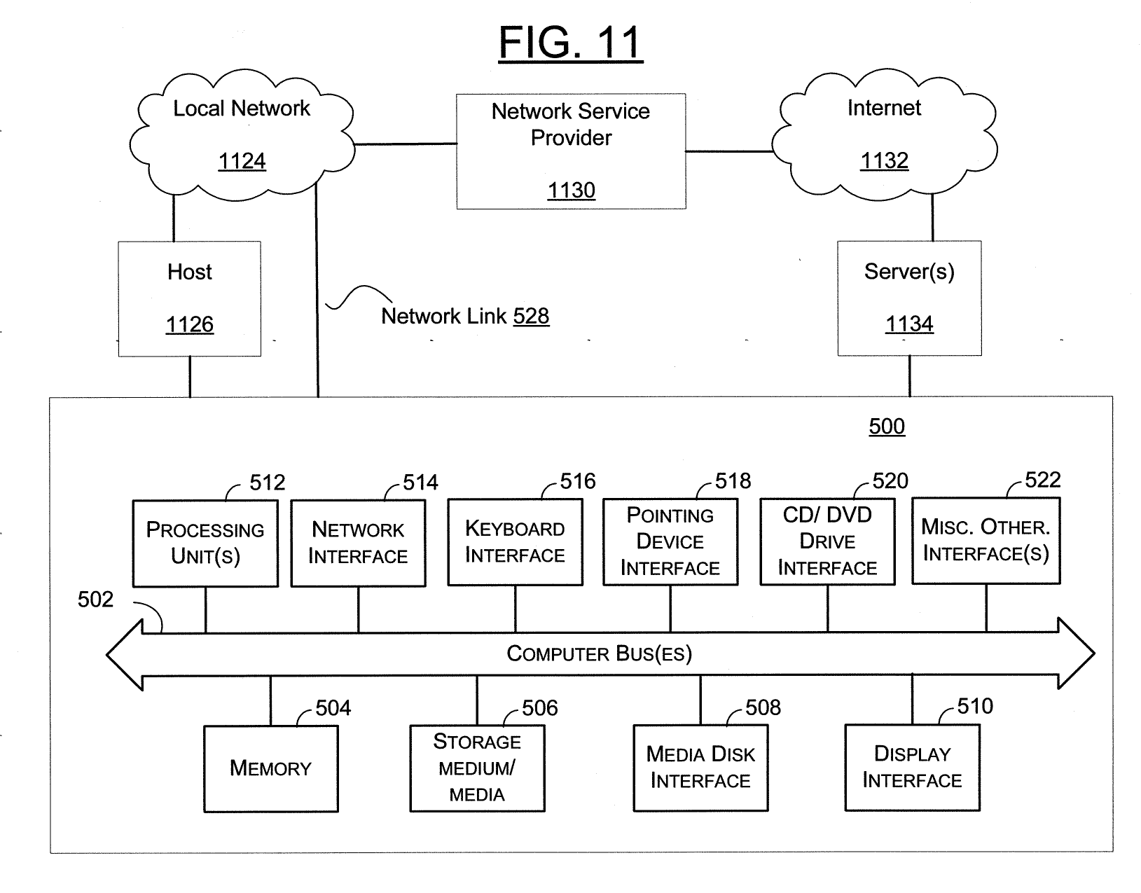

FIG. 11 is a block diagram illustrating an internal architecture of a computing device, e.g., a computing device such as server or user computing device, in accordance with one or more embodiments of the present disclosure. FIG. 11 illustrates a computer system upon which some exemplary embodiments of the present disclosure may be implemented. Although computer system 1100 is depicted with respect to a particular device or equipment, it is contemplated that other devices or equipment (e.g., network elements, servers, processors) within can deploy the illustrated hardware and components of system 1100.

As shown in FIG. 11, internal architecture 1100 includes one or more processing units, processors, or processing cores, (also referred to herein as CPUs) 1112, which interface with at least one computer bus 1102. Also interfacing with computer bus 1102 are computer-readable medium, or media, 1106, network interface 1114, memory 1104, e.g., random access memory (RAM), run-time transient memory, read only memory (ROM), media disk drive interface 1120 as an interface for a drive that can read and/or write to media including removable media such as floppy, CD-ROM, DVD, media, display interface 1110 as interface for a monitor or other display device, keyboard interface 1116 as interface for a keyboard, pointing device interface 1118 as an interface for a mouse or other pointing device, and miscellaneous other interfaces not shown individually, such as parallel and serial port interfaces and a universal serial bus (USB) interface.

Memory 1104 interfaces with computer bus 1102 so as to provide information stored in memory 1104 to CPU 1112 during execution of software programs such as an operating system, application programs, device drivers, and software modules that comprise program code, and/or computer-executable process steps, incorporating functionality described herein, e.g., one or more of process flows described herein. CPU 1112 first loads computer-executable process steps from storage, e.g., memory 1104, computer-readable storage medium/media 1106, removable media drive, and/or other storage device. CPU 1112 can then execute the stored process steps in order to execute the loaded computer-executable process steps. Stored data, e.g., data stored by a storage device, can be accessed by CPU 1112 during the execution of computer-executable process steps.

Persistent storage, e.g., medium/media 1106, can be used to store an operating system and one or more application programs. Persistent storage can also be used to store device drivers, such as one or more of a digital camera driver, monitor driver, printer driver, scanner driver, or other device drivers, web pages, content files, playlists and other files. Persistent storage can further include program modules and data files used to implement one or more embodiments of the present disclosure, e.g., listing selection module(s), targeting information collection module(s), and listing notification module(s), the functionality and use of which in the implementation of the present disclosure are discussed in detail herein.

Network link 1128 typically provides information communication using transmission media through one or more networks to other devices that use or process the information. For example, network link 1128 may provide a connection through local network 1124 to a host computer 1126 or to equipment operated by an Network or Internet Service Provider (ISP) 1130. ISP equipment in turn provides data communication services through the public, world-wide packet-switching communication network of networks now commonly referred to as the Internet 1132.

A computer called a server host 1134 connected to the Internet 1132 hosts a process that provides a service in response to information received over the Internet 1132. For example, server host 1134 hosts a process that provides information representing video data for presentation at display 1110. It is contemplated that the components of system 1100 can be deployed in various configurations within other computer systems, e.g., host and server.

At least some embodiments of the present disclosure are related to the use of computer system 1100 for implementing some or all of the techniques described herein. According to one embodiment, those techniques are performed by computer system 1100 in response to processing unit 1112 executing one or more sequences of one or more processor instructions contained in memory 1104. Such instructions, also called computer instructions, software and program code, may be read into memory 1104 from another computer-readable medium 1106 such as storage device or network link Execution of the sequences of instructions contained in memory 1104 causes processing unit 1112 to perform one or more of the method steps described herein. In alternative embodiments, hardware, such as ASIC, may be used in place of or in combination with software. Thus, embodiments of the present disclosure are not limited to any specific combination of hardware and software, unless otherwise explicitly stated herein.

The signals transmitted over network link and other networks through communications interface, carry information to and from computer system 1100. Computer system 1100 can send and receive information, including program code, through the networks, among others, through network link and communications interface. In an example using the Internet, a server host transmits program code for a particular application, requested by a message sent from computer, through Internet, ISP equipment, local network and communications interface. The received code may be executed by processor 1102 as it is received, or may be stored in memory 1104 or in storage device or other non-volatile storage for later execution, or both.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers, or be loaded and executed by one or more servers. One or more modules may be grouped into an engine or an application.

For the purposes of this disclosure the term “user”, “subscriber” or “customer” should be understood to refer to a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

1. (canceled)

2. A method comprising:
receiving, at a computing device, an indication that a web page was received by a first user;
initiating, via the computing device, an instant message (IM) session in response to the received web page,
associating, via the computing device, the IM session associated with the web page, displaying, at the computing device, a user interface (UI) for the IM session;
identifying a plurality of users associated with the IM session, the plurality of users including at least a second user; and
enabling, via the computing device over the network, communication between the first user and a second user on said page via the IM session.

3. The method of claim 2 further comprising:
transmitting identifying information associated with said user over said network;
confirming said identifying information with information stored in storage located on said network.

4. The method of claim 2, wherein said IM session is specific for said page, said IM session enabling only said user and other users currently visiting said page to communicate with each other.

5. The method of claim 2, further comprising: initiating the IM session for a domain associated with said page.

6. The method of claim 2, wherein enabling communication between the first user and a second user on said page via the IM session enables each user on a page within said domain to communicate with another user on any page within said domain.

7. The method of claim 5, wherein each page within said domain has a page-specific IM session, each page-specific session enabling only users currently visiting a page associated with the page-specific session to communicate with each other.

8. The method of claim 2, wherein initiating the IM session further comprises:
determining whether said user desires to initiate a page level session or a domain level session; and
initiating a session based on said determination.

9. The method of claim 8, wherein said determination is selected from a group consisting of user preferences, network capabilities, amount of users on a page, amount of users on pages within a domain and device capabilities.

10. The method of claim 2, wherein the IM UI further comprises:
a first portion, said first portion visibly displaying communication activity between users; and
a second portion, said second portion visibly displaying information indicating users currently associated with said page.

11. The method of claim 10, wherein said second portion further comprising:
visibly displaying user information associated with other users said user has an established relationship, said user information comprising identifying information for each user.

12. The method of claim 10, wherein said information further comprises a total number of users currently associated with said page.

13. The method of claim 10, wherein said users associated with said page comprises users currently visiting pages within a common domain.

14. The method of claim 10, wherein said users associated with said page comprises users currently visiting a specific page.

15. A non-statutory computer-readable storage medium tangibly encoded with computer-executable instructions, that when executed by a processor associated with a computing device, perform a method comprising:
receiving, at a computing device, an indication that a web page was received by a first user;
initiating, via the computing device, an instant message (IM) session in response to the received web page,
associating, via the computing device, the IM session associated with the web page,
displaying, at the computing device, a user interface (UI) for the IM session;
identifying a plurality of users associated with the IM session, the plurality of users including at least a second user; and
enabling, via the computing device over the network, communication between the first user and a second user on said page via the IM session.

16. The non-statutory computer-readable storage medium of claim 15, said initiating the IM session further comprising:
transmitting identifying information associated with said user over said network;
confirming said identifying information with information stored in storage located on said network.

17. The non-statutory computer-readable storage medium of claim 15, wherein said IM session is specific for said page, said IM session enabling only said user and other users currently visiting said page to communicate with each other.

18. The non-statutory computer-readable storage medium of claim 15, further comprising:
initiating the IM session for a domain associated with said page,

19. The non-statutory computer-readable storage medium of claim 15, wherein said domain IM session enables each user on a page within said domain to communicate with another user on any page within said domain.

20. The non-statutory computer-readable storage medium of claim 15, wherein each page within said domain has a page-specific IM session, each page-specific session enabling only users currently visiting a page associated with the page-specific session to communicate with each other.

21. A system comprising:
at least one computing device comprising:
a processor; and
a storage medium for tangibly storing thereon program logic for execution by the processor, the program logic comprising:
logic for receiving, at a computing device, an indication that a web page was received by a first user;
logic for initiating, via the computing device, an instant message (IM) session in response to the received web page,
logic for associating, via the computing device, the IM session associated with the web page,
logic for displaying, at the computing device, a user interface (UI) for the IM session;
logic for identifying a plurality of users associated with the IM session, the plurality of users including at least a second user; and
logic for enabling, via the computing device over the network, communication between the first user and a second user on said page via the IM session.
